(19) United States
(12) Patent Application Publication
(10) Pub. No.: US 2025/0243064 A1
(43) Pub. Date: Jul. 31, 2025

(54) LITHIUM MANGANESE IRON PHOSPHATE MATERIAL AND METHOD FOR PREPARING THE SAME, CATHODE PLATE, AND SECONDARY BATTERY

(71) Applicants: HUBEI WANRUN NEW ENERGY TECHNOLOGY CO., LTD., Shiyan, Hubei (CN); HUBEI YUHAO HIGH-TECH NEW MATERIAL CO., LTD., Shiyan, Hubei (CN)

(72) Inventors: Shiqi LIU, Shiyan (CN); Fei LV, Shiyan (CN); Kai GAO, Shiyan (CN); Qin WANG, Shiyan (CN); Shitao CHEN, Shiyan (CN)

(21) Appl. No.: 18/854,579

(22) PCT Filed: Aug. 26, 2024
(86) PCT No.: PCT/CN2024/114441

§ 371 Date: Oct. 7, 2024

(30) Foreign Application Priority Data
Aug. 28, 2023 (CN) 202311097874.9

(51) Int. Cl. C01B 25/37; C01B 25/26; H01M 10/052

(52) U.S. Cl. CPC C01B 25/375; C01B 25/265; H01M 10/052; C01P 2004/03; C01P 2004/04; C01P 2004/61; C01P 2004/62; C01P 2006/11; C01P 2006/12; C01P 2006/40

(57) ABSTRACT

In one aspect, a lithium manganese iron phosphate material includes a core, and a material of the core is represented by a general formula of LiₓMg_{y}Mn_{z}FeₐAl_{b}PO₄, where x is ranged from 1.008 to 1.05, y is ranged from 0 to 0.006, z is ranged from 0.4 to 0.6, a is ranged from 0.388 to 0.6, and b is ranged from 0 to 0.012.

### RELATED APPLICATIONS

This application is an U.S. national phase application under 35 U.S.C. § 371 based upon international patent application No. PCT/CN2024/114441 filed on Aug. 26, 2024, which itself claims priority to Chinese patent application No. 202311097874.9, filed on Aug. 28, 2023, entitled “METHOD FOR PREPARING LITHIUM MANGANESE IRON PHOSPHATE”. The contents of the above identified applications are incorporated herein by reference in their entireties.

### TECHNICAL FIELD

The present disclosure relates to the technical field of lithium-ion batteries, particularly to a lithium manganese iron phosphate material and a method for preparing the same, a cathode plate, and a secondary battery.

### BACKGROUND

Lithium manganese iron phosphate and lithium iron phosphate are both phosphate-based materials. The core difference between them lies only in the addition of manganese elements and the decrease of iron elements in the former. In terms of performance, while retaining the advantages of lithium iron phosphate, such as long cycle life, high thermal stability and strong safety, the lithium manganese iron phosphate can increase the voltage platform of lithium iron phosphate batteries (3.4 V to 3.5V) to 4.3V, and increase the energy density by 15% to 20%. In terms of cost, as manganese is widely present in nature and has abundant resources, increasing the proportion of manganese in the cathode material has a significant effect on reducing the cost of batteries.

At present, the preparation processes of lithium manganese iron phosphate include a solid phase method and a hydrothermal method. In the solid phase method, manganese salts, iron salts (such as oxides, phosphates, oxalates, etc.), lithium carbonate, and phosphates are slurried with water and ground, and then spray-dried and calcined to obtain lithium manganese iron phosphate. However, segregation of manganese elements and iron elements occurs in the preparation of the lithium manganese iron phosphate. As lithium manganese phosphate has extremely low electrical conductivity, the presence of a separate lithium manganese phosphate phase will result in a very low capacity. In the hydrothermal method, lithium salts, iron salts, manganese salts, and phosphates are mixed and added to water, and then reacted under high temperature and high pressure, however the resulting lithium manganese iron phosphate has a low crystallinity.

In view of this, the present disclosure is hereby presented.

### SUMMARY

According to at least some embodiments of the present disclosure, a lithium manganese iron phosphate material, and a method for preparing the lithium manganese iron phosphate material, a cathode plate including the lithium manganese iron phosphate material, a secondary battery, and an electrical device are provided.

In a first aspect, a lithium manganese iron phosphate material is provided. The lithium manganese iron phosphate material includes a core. A material of the core is represented by a general formula of LiₓMg_{y}Mn_{z}FeₐAl_{b}PO₄, where x is ranged from 1.002 to 1.05, y is ranged from 0 to 0.009, z is ranged from 0.4 to 0.6, a is ranged from 0.388 to 0.6, and b is ranged from 0 to 0.012.

Optionally, the lithium manganese iron phosphate material further includes a coating layer coated on a surface of the core. A material of the coating layer includes a carbon material. A mass fraction of the carbon material is ranged from 1.5% to 2.5%, and/or a coverage rate of the carbon material is ranged from 98.0% to 99.9%.

Optionally, the lithium manganese iron phosphate material satisfies at least one of the following conditions:
(1) a sphericity of the lithium manganese iron phosphate material is ranged from 0.7 to 1.0;
(2) an average primary particle size of the lithium manganese iron phosphate material is ranged from 170 nm to 220 nm;
(3) a secondary particle size of the lithium manganese iron phosphate material satisfies: 0.2 μm to 0.6 μm of D10 particle size, 1.5 μm to 3 μm of D50 particle size, and 5 μm to 15 μm of D90 particle size;
(4) a compacted density of the lithium manganese iron phosphate material is ranged from 2.35 g/mL to 2.45 g/mL;
(5) a tap density of the lithium manganese iron phosphate material is ranged from 1.1 g/mL to 1.2 g/mL;
(6) a specific surface area of the lithium manganese iron phosphate material is ranged from 13.5 m²/g to 15.5 m²/g;
(7) a powder resistivity of the lithium manganese iron phosphate material is less than 15 Ω·cm;
(8) a manganese dissolution rate of the lithium manganese iron phosphate material is less than or equal to 0.05% of a manganese content in the lithium manganese iron phosphate material; and
(9) a specific capacity of the lithium manganese iron phosphate material is ranged from 160 mAh/g to 169 mAh/g.

In a second aspect, a method for preparing a lithium manganese iron phosphate material is provided. The method includes the following steps:
mixing a mixed solution I with a phosphoric acid solution to obtain a mixed solution II, the mixed solution I including a first manganese salt, a first iron salt, and a first lithium salt which are all soluble salts; and
subjecting the mixed solution II to spray drying, calcination and pulverization in sequence to obtain the lithium manganese iron phosphate material;
wherein the lithium manganese iron phosphate material includes a core, and a material of the core is represented by a general formula of LiₓMg_{y}Mn_{z}FeₐAl_{b}PO₄, where x is ranged from 1.002 to 1.05, y is ranged from 0 to 0.009, z is ranged from 0.4 to 0.6, a is ranged from 0.388 to 0.6, and b is ranged from 0 to 0.012.

Optionally, the mixed solution I further includes a first magnesium salt and a first aluminum salt which are both soluble salts.

Optionally, in the mixed solution II, a molar ratio of manganese elements, iron elements, lithium elements, and phosphorus elements is (0.4-0.6):(0.4-0.6):(1.02-1.05):1.

Optionally, in the mixed solution II, a molar ratio of magnesium elements, aluminum elements, and manganese elements is (0.01-0.02):(0.005-0.01):1.

Optionally, the lithium manganese iron phosphate material further includes a coating layer coated on a surface of the core, and a material of the coating layer includes a carbon material. In the step of mixing the mixed solution I with the phosphoric acid solution to obtain the mixed solution II, the method further includes:
mixing a soluble organic carbon source with the mixed solution I and the phosphoric acid solution.

Optionally, the soluble organic carbon source includes a first carbon source and a second carbon source; and/or, the first carbon source includes m-phenylenediamine and/or p-hydroxyaniline; and/or, the second carbon source includes at least one of glucose, sucrose, polyethylene glycol, and starch; and/or, a mass ratio of the first carbon source to the second carbon source is (5-10):(90-95).

Optionally, a content of carbon elements in the lithium manganese iron phosphate material is ranged from 1.5 wt % to 2.5 wt %.

Optionally, the mixed solution I is prepared by reacting a mixed material containing an iron powder, a manganese powder and lithium carbonate with an acetic acid solution, solid-liquid separation, and then obtaining the mixed solution I; and/or, the mixed material further includes a magnesium powder and an aluminum powder.

Optionally, an inlet air temperature for the spray drying is ranged from 250° C. to 350° C.; and/or, a spray material is obtained after the spray drying, a particle size of the spray material is ranged from 3 μm to 8 μm, and a moisture content of the spray material is less than 0.8 wt %.

Optionally, the calcination includes: heating to a temperature ranged from 650° C. to 690° C. and holding for 9 hours to 13 hours under an inert atmosphere, and then cooling.

Optionally, the pulverization includes: pulverizing a calcined material after calcination to a particle size of 1.5 μm to 3 μm.

In a third aspect, a cathode plate is provided. The cathode plate includes a current collector, and a cathode material disposed on at least one side of the current collector in a thickness direction. The cathode material includes the lithium manganese iron phosphate material as described in the first aspect.

In a fourth aspect, a secondary battery is provided. The secondary battery includes a cathode plate, a separator, and an anode plate that are stacked one on another. The cathode plate is as described in the third aspect.

In a fifth aspect, an electrical device is provided. The electrical device includes a plurality of batteries connected in series and/or in parallel. At least one of the batteries is the secondary battery as described in the fourth aspect.

The details of one or more embodiments of the present disclosure are set forth in the accompanying drawings and the description below. Other features, objects and advantages of the present disclosure will become apparent from the description, the accompanying drawings, and the claims.

### BRIEF DESCRIPTION OF THE DRAWINGS

In order to illustrate the technical solutions in the embodiments of the present disclosure or in the prior art more clearly, the drawings used for describing the embodiments or the prior art will be described briefly. Apparently, the following described drawings are merely for the embodiments of the present disclosure, and other drawings can be derived by those of ordinary skill in the art without any creative effort.

FIG. 1 is a manganese (Mn) element distribution diagram of a lithium manganese iron phosphate material provided according to an embodiment of the present disclosure analyzed by EDS.

FIG. 2 is an iron (Fe) element distribution diagram of a lithium manganese iron phosphate material provided according to an embodiment of the present disclosure analyzed by EDS.

FIG. 3 is a SEM image of a lithium manganese iron phosphate material in Example 12 of the present disclosure.

FIG. 4 is a TEM image of the lithium manganese iron phosphate material in Example 12 of the present disclosure.

FIG. 5 is a 0.1C charge and discharge curves of the lithium manganese iron phosphate material in Example 12 of the present disclosure.

FIG. 6 is a 1C charge and discharge curves of the lithium manganese iron phosphate material in Example 12 of the present disclosure.

### DETAILED DESCRIPTION

The technical solution of the present disclosure will be clearly and completely described below in conjunction with the accompanying drawings and specific embodiments. However, a person skilled in the art will understand that the embodiments described below are part of the embodiments of the present disclosure, rather than all of the embodiments, and are only used to illustrate the present disclosure and should not be constructed as limiting the scope of the present disclosure. All other embodiments obtained by a person skilled in the art based on the embodiments in the present disclosure without creative efforts are within the scope of the present disclosure. Embodiments with specific conditions not indicated are carried out under conventional conditions or conditions recommended by the manufacturer. The reagents or instruments used without indication of manufacturer are all conventional products that are commercially available.

In a first aspect, a lithium manganese iron phosphate material is provided according to an embodiment of the present disclosure. The lithium manganese iron phosphate material includes a core, and a material of the core is represented by a general formula of LiₓMg_{y}Mn_{z}FeₐAl_{b}PO₄, where x is ranged from 1.002 to 1.05, y is ranged from 0 to 0.009, z is ranged from 0.4 to 0.6, a is ranged from 0.388 to 0.6, and b is ranged from 0 to 0.012.

As an example, x can be 1.003, 1.007, 1.008, 1.01, 1.015, 1.02, 1.025, 1.03, 1.035, 1.04, 1.045, or 1.05. As an example, y can be 0, 0.001, 0.002, 0.003, 0.004, 0.005, 0.006, 0.007, 0.008, or 0.009. As an example, z can be 0.4, 0.5, or 0.6. As an example, a can be 0.388, 0.4, 0.45, 0.5, 0.55, or 0.6. As an example, b can be 0, 0.001, 0.002, 0.003, 0.004, 0.005, 0.006, 0.007, 0.008, 0.009, 0.01, 0.011, or 0.012.

The lithium manganese iron phosphate material can be undoped with magnesium and aluminum, at which case the general formula of the lithium manganese iron phosphate material is LiₓMn_{z}FeₐPO₄, where x is ranged from 1.02 to 1.05, z is ranged from 0.4 to 0.6, and a is ranged from 0.4 to 0.6. Alternatively, the lithium manganese iron phosphate material can be doped with magnesium and aluminum, at which case magnesium is doped at the Li⁺ position, and aluminum is doped at the Fe³⁺ position, and the values of x, y, z, a and b can be obtained by calculation. In the case of doping magnesium and aluminum, ion doping can be formed, which further improves the ionic electrical conductivity of the lithium manganese iron phosphate material. Furthermore, the doping of magnesium can significantly reduce the dissolution of manganese and improve the cycling performance, and the doping of aluminum can further improve the compacted density and rate capability of the lithium manganese iron phosphate material.

In the case where the lithium manganese iron phosphate material is undoped with magnesium and aluminum, the above-mentioned x can be 1.02, 1.03, 1.04, or 1.05, z can be 0.4, 0.5, or 0.6, and a can be 0.4, 0.5, or 0.6.

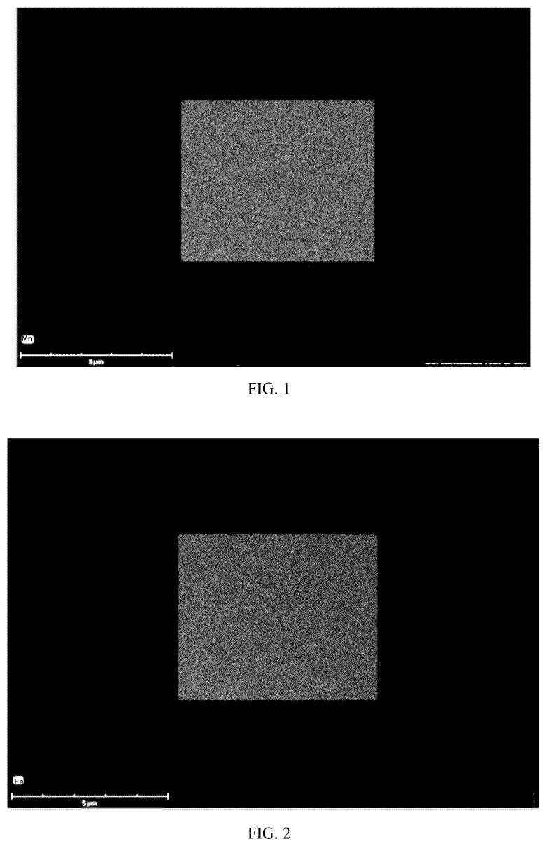

It is found through EDS test that manganese and iron are relatively uniformly distributed in the lithium manganese iron phosphate material according to an embodiment of the present disclosure, almost without segregation of manganese and iron. The specific test results are shown in FIGS. 1 and 2.

In view of the low crystallinity of and the manganese segregation phase in the lithium manganese iron phosphate material in the related art, the lithium manganese iron phosphate material provided in the embodiments of the present disclosure can have up to 97% or more of crystallinity and relatively less manganese segregation phase, with reduced manganese segregation, thereby improving the capacity and electrical conductivity of the lithium manganese iron phosphate material.

In some alternative embodiments, a ratio of y:b:z is (0.01-0.02):(0.005-0.01):1. Further, a ratio ofy:b:z is (0.012-0.018):(0.007-0.009):1.

When it is referred to that a ratio of y:b:z is (0.01-0.02):(0.005-0.01):1, it means that y:b:z can be 0.01:0.005:1, or y:b:z can be 0.02:0.005:1, or y:b:z can be 0.015:0.005:1, or y:b:z can be 0.012:0.005:1, or y:b:z can be 0.01:0.01:1, or y:b:z can be 0.01:0.006:1, or y:b:z can be 0.01:0.007:1, or y:b:z can be 0.01:0.008:1, or y:b:z can be 0.01:0.009:1, or y:b:z can be 0.012:0.006:1, or y:b:z can be 0.012:0.007:1, or y:b:z can be 0.012:0.008:1, or y:b:z can be 0.012:0.009:1, or y:b:z can be 0.018:0.006:1, or y:b:z can be 0.018:0.007:1, or y:b:z can be 0.018:0.008:1, or y:b:z can be 0.018:0.009:1, or y:b:z can be 0.015:0.006:1, or y:b:z can be 0.015:0.007:1, or y:b:z can be 0.015:0.008:1, or y:b:z can be 0.015:0.009:1.

In these embodiments, if magnesium and aluminum are doped too much, the capacity of the lithium manganese iron phosphate material will be low and the cycling performance will be reduced.

In some embodiments, a carbon material is coated on a surface of the lithium manganese iron phosphate material. A mass fraction of the carbon material is ranged from 1.5 wt % to 2.5 wt %, and/or a coverage rate of the carbon material is ranged from 98.0% to 99.9%.

When it is referred to that a mass fraction of the carbon material is 1.5% to 2.5%, it means that the mass fraction of the carbon material can be 1.5%, 1.6%, 1.7%, 1.8%, 1.9%, 2.0%, 2.1%, 2.2%, 2.3%, 2.4%, or 2.5%. When it is referred to that a coverage rate of the carbon material is 98.0% to 99.9%, it means that the coverage rate of the carbon material can be 98.0%, 98.1%, 98.2%, 98.3%, 98.4%, 98.5%, 98.6%, 98.7%, 98.8%, 98.9%, 99.0%, 99.1%, 99.2%, 99.3%, 99.4%, 99.5%, 99.6%, 99.7%, 99.8%, or 99.9%.

In these embodiments, the surface of the lithium manganese iron phosphate material is entirely coated with the carbon material, which can further improve the electrical conductivity of the lithium manganese iron phosphate material and reduce the manganese dissolution rate.

In some embodiments, the lithium manganese iron phosphate material satisfies at least one of the following conditions:
(1) a sphericity of the lithium manganese iron phosphate material is ranged from 0.7 to 1.0;
(2) an average primary particle size of the lithium manganese iron phosphate material is ranged from 170 nm to 220 nm;
(3) a secondary particle size of the lithium manganese iron phosphate material satisfies: 0.2 μm to 0.6 μm of D10 particle size, 1.5 μm to 3 μm of D50 particle size, and 5 μm to 15 μm of D90 particle size;
(4) a compacted density of the lithium manganese iron phosphate material is ranged from 2.35 g/mL to 2.45 g/mL;
(5) a tap density of the lithium manganese iron phosphate material is ranged from 1.1 g/mL to 1.2 g/mL;
(6) a specific surface area of the lithium manganese iron phosphate material is ranged from 13.5 m²/g to 15.5 m²/g;
(7) a powder resistivity of the lithium manganese iron phosphate material is less than 15 Ω·cm;
(8) a manganese dissolution rate of the lithium manganese iron phosphate material is less than or equal to 0.05% of a manganese content in the lithium manganese iron phosphate material; and
(9) a specific capacity of the lithium manganese iron phosphate material is ranged from 160 mAh/g to 169 mAh/g.

When it is referred to that a sphericity of the lithium manganese iron phosphate material is ranged from 0.7 to 1.0, it means that the sphericity of the lithium manganese iron phosphate material can be 0.7, 0.8, 0.9, 1.0, or any value between 0.7 to 1.0.

When it is referred to that an average primary particle size of the lithium manganese iron phosphate material is ranged from 170 nm to 220 nm, it means that the average primary particle size of the lithium manganese iron phosphate material can be 170 nm, 175 nm, 180 nm, 185 nm, 190 nm, 195 nm, 200 nm, 205 nm, 210 nm, 215 nm, 220 nm, or any value between 170 nm to 220 nm.

When it is referred to that a secondary particle size of the lithium manganese iron phosphate material satisfies: 0.2 μm to 0.6 μm of D10 particle size, 1.5 μm to 3 μm of D50 particle size, and 5 μm to 15 μm of D90 particle size, it means that D10 particle size can be 0.2 μm, 0.3 μm, 0.4 μm, 0.5 μm, or 0.6 μm, etc.; D50 particle size can be 1.5 μm, 2.0 μm, 2.5 μm, or 3 μm, etc.; and D90 particle size can be 5 μm, 6 μm, 7 μm, 8 μm, 9 μm, 10 μm, 11 μm, 12 μm, 13 μm, 14 μm, or 15 μm, etc. The D10 particle size, D50 particle size, and D90 particle size can be measured by a laser particle size analyzer.

When it is referred to that a compacted density of the lithium manganese iron phosphate material is ranged from 2.35 g/mL to 2.45 g/mL, it means that the compacted density of the lithium manganese iron phosphate material can be 2.35 g/mL, 2.36 g/mL, 2.37 g/mL, 2.38 g/mL, 2.39 g/mL, 2.40 g/mL, 2.41 g/mL, 2.42 g/mL, 2.43 g/mL, 2.44 g/mL, 2.45 g/mL, etc.

When it is referred to that a tap density of the lithium manganese iron phosphate material is ranged from 1.1 g/mL to 1.2 g/mL, it means that the tap density of the lithium manganese iron phosphate material is 1.1 g/mL, 1.11 g/mL, 1.12 g/mL, 1.13 g/mL, 1.14 g/mL, 1.15 g/mL, 1.16 g/mL, 1.17 g/mL, 1.18 g/mL, 1.19 g/mL, 1.2 g/mL, etc.

When it is referred to that a specific surface area of the lithium manganese iron phosphate material is ranged from 13.5 m²/g to 15.5 m²/g, it means that the specific surface area of the lithium manganese iron phosphate material can be 13.5 m²/g, 13.6 m²/g, 13.7 m²/g, 13.8 m²/g, 13.9 m²/g, 14.0 m²/g, 14.1 m²/g, 14.2 m²/g, 14.3 m²/g, 14.4 m²/g, 14.5 m²/g, 14.6 m²/g, 14.7 m²/g, 14.8 m²/g, 14.9 m²/g, 15.0 m²/g, 15.1 m²/g, 15.2 m²/g, 15.3 m²/g, 15.4 m²/g, 15.5 m²/g, etc.

When it is referred to that a powder resistivity of the lithium manganese iron phosphate material is less than 15 Ω·cm, it means that the powder resistivity of the lithium manganese iron phosphate material can be 14 Ω·cm, 14.1 Ω·cm, 14.2 Ω·cm, 14.3 Ω·cm, 14.4 Ω·cm, 14.5 Ω·cm, 14.6 Ω·cm, 14.7 Ω·cm, 14.8 Ω·cm, 14.9 Ω·cm, 13 Ω·cm, 13.1 Ω·cm, 13.2 Ω·cm, 13.3 Ω·cm, 13.4 Ω·cm, 13.5 Ω·cm, 13.6 Ω·cm, 13.7 Ω·cm, 13.8 Ω·cm, 13.9 Ω·cm, or 12 Ω·cm, etc.

When it is referred to that a manganese dissolution rate of the lithium manganese iron phosphate material is less than or equal to 0.05% of a manganese content in the lithium manganese iron phosphate material, it means that the manganese dissolution rate of the lithium manganese iron phosphate material accounts for 0.05%, 0.04%, 0.03%, 0.02% or 0.01%, etc. of the manganese content in the lithium manganese iron phosphate material.

When it is referred to that a specific capacity of the lithium manganese iron phosphate material is ranged from 160 mAh/g to 169 mAh/g, it means that the specific capacity of the lithium manganese iron phosphate material can be 160 mAh/g, 161 mAh/g, 162 mAh/g, 163 mAh/g, 164 mAh/g, 165 mAh/g, 166 mAh/g, 167 mAh/g, 168 mAh/g, or 169 mAh/g, etc.

In these embodiments, the lithium manganese iron phosphate material has high particle sphericity, small particle size, small specific surface area, high compacted density and tap density, and low powder resistivity, which ensures a high degree of compactness at manufacture of cathode plates and excellent electrical properties such as specific capacity.

In a second aspect, some embodiments of the present disclosure provide a method for preparing a lithium manganese iron phosphate material, including the following steps:

Step 10, mixing a mixed solution I with a phosphoric acid solution to obtain a mixed solution II, the mixed solution I including a first manganese salt, a first iron salt, and a first lithium salt which are all soluble salts; and

Step 20, subjecting the mixed solution II to spray drying, calcination and pulverization in sequence to obtain the lithium manganese iron phosphate material.

The lithium manganese iron phosphate material includes a core, and a material of the core is represented by a general formula of LiₓMg_{y}Mn_{z}FeₐAl_{b}PO₄, where x is ranged from 1.008 to 1.05, y is ranged from 0 to 0.009, z is ranged from 0.4 to 0.6, a is ranged from 0.388 to 0.6, and b is ranged from 0 to 0.012.

As an example, x can be 1.003, 1.007, 1.008, 1.01, 1.015, 1.02, 1.025, 1.03, 1.035, 1.04, 1.045, or 1.05. As an example, y can be 0, 0.001, 0.002, 0.003, 0.004, 0.005, 0.006, 0.007, 0.008, or 0.009. As an example, z can be 0.4, 0.5, or 0.6. As an example, a can be 0.388, 0.4, 0.45, 0.5, 0.55, or 0.6. As an example, b can be 0, 0.001, 0.002, 0.003, 0.004, 0.005, 0.006, 0.007, 0.008, 0.009, 0.01, 0.011, or 0.012.

In order to improve the poor electrical properties of the lithium manganese iron phosphate prepared in the related art, embodiments of the present disclosure provide a wet method for preparing the lithium manganese iron phosphate. Specifically, a mixed solution I containing a first manganese salt, a first iron salt and a first lithium salt is uniformly mixed with a phosphoric acid solution to obtain a mixed solution II; and then the mixed solution II is spray-dried, calcined and pulverized in sequence, thereby obtaining the lithium manganese iron phosphate material.

In the conventional solid phase method, the mixing size is limited by the particle size and is relatively large, which is difficult to ensure uniform mixing of manganese and iron, thereby resulting in a segregation phenomenon. The capacity at regions where manganese is enriched is low, resulting in relatively poor capacity, poor cycling performance, and obvious manganese dissolution for the entire product. Compared to the conventional solid phase method, the method for preparing the lithium manganese iron phosphate material provided in the embodiments of the present disclosure allows raw materials to mix and disperse in the aqueous solution in ionic states thereof, with a very small mixing size even reaching the ionic scale, which ensures uniform mixing of manganese and iron, thereby reducing manganese segregation and manganese dissolution, further improving the cycling performance and capacity of the product.

In addition, in the present disclosure, since the raw materials are mixed at an ion level before spray drying, the calcination temperature in the process of subsequent calcination is reduced. At a relatively low calcination temperature, the ion migration distance is very short, and the ions are reacted and fused very quickly, thus achieving a relatively high compacted density. Moreover, the calcination is not carried out at a high temperature, which avoids the formation of large particles, thereby resulting in a relatively high capacity. In a solid phase method in the related art, segregation of manganese and iron occurs in the preparation of lithium manganese iron phosphate materials, co-precipitation of manganese and iron requires a long process flow and the co-precipitation effect is difficult to guarantee. In contrast, the present preparation method can reduce the process flow and the difficulty of co-precipitation while effectively reducing manganese segregation. The hydrothermal method in the related art is difficult to achieve carbon coating and large-scale production, in contrast the present preparation method facilitates the simultaneous carbon coating and can achieve large-scale production.

In some embodiments, the first manganese salt includes at least one of manganese acetate, manganese chloride, and manganese nitrate; and/or, the first iron salt includes at least one of ferrous acetate and ferrous chloride; and/or, the first lithium salt includes at least one of lithium acetate and lithium carbonate.

In these embodiments, during the spray drying, due to the volatility of acetic acid, hydrochloric acid and nitric acid, the acetate ions, chloride ions, and nitrate ions in the mixed solution II will be preferentially volatilized together with hydrogen ions (i.e., in a form of acetic acid, hydrochloric acid, and nitric acid). In other words, low boiling point acids are employed in the preparation, and they will be evaporated and volatilized together with water at high temperature. After the anions in the mixed solution II are volatilized due to the low boiling point, the remaining materials form a spray precursor, which is then calcined to obtain a lithium manganese iron phosphate material with high performances.

In some embodiments, the mixed solution I further includes a first magnesium salt and a first aluminum salt which are both soluble salts.

In these embodiments, the first magnesium salt and the first aluminum salt in the mixed solution I are used as dopants to introduce aluminum and magnesium, which can form ion doping, thereby further improving the ionic conductivity. Furthermore, the doping of magnesium can significantly reduce the dissolution of manganese and improve the cycling performance, and the doping of aluminum can further improve the compacted density and rate capability of the lithium manganese iron phosphate material.

In some embodiments, the first magnesium salt includes at least one of magnesium acetate, magnesium chloride, and magnesium nitrate; and/or, the first aluminum salt includes at least one of aluminum acetate, aluminum chloride, and aluminum nitrate.

In these embodiments, during the spray drying, due to the volatility of acetic acid, hydrochloric acid and nitric acid, the acetate ions, chloride ions, and nitrate ions in the mixed solution II will be preferentially volatilized together with hydrogen ions (i.e., in a form of acetic acid, hydrochloric acid, and nitric acid). In other words, low boiling point acids are employed in the preparation, and they will be evaporated and volatilized together with water at high temperature. After the anions in the mixed solution II are volatilized due to the low boiling point, the remaining materials form a spray precursor, which is then calcined to obtain an aluminum and magnesium doped lithium manganese iron phosphate material with high performances.

In some embodiments, the lithium manganese iron phosphate material further includes a coating layer coated on a surface of the core, and a material of the coating layer includes a carbon material. In the step of mixing the mixed solution I with the phosphoric acid solution to obtain the mixed solution II, the method further includes mixing a soluble organic carbon source with the mixed solution I and the phosphoric acid solution.

In some embodiments, the soluble organic carbon source includes a first carbon source and a second carbon source. The first carbon source includes m-phenylenediamine and/or p-hydroxyaniline, and the second carbon source includes at least one of glucose, sucrose, polyethylene glycol, and starch.

In some embodiments, a mass ratio of the first carbon source to the second carbon source is (5-10):(90-95). Typically but not restrictively, for example, the mass ratio of the first carbon source to the second carbon source can be 5:95, 6:94, 7:93, 8:92, 9:91, 10:90, or a range defined by any two of the values.

The structure of the first carbon source contains both a benzene ring and an amino group (i.e., containing nitrogen). The carbon source produced by the benzene ring has a high degree of graphitization, which ensures good electrical conductivity and very low powder resistivity. In addition, due to the presence of the amino group, nitrogen doping is introduced, which further improves the electrical conductivity of the carbon. The second carbon source provides a carbon source for coating.

In the present disclosure, if the content of the first carbon source is too high, the carbon content will be too high, which will result in a relatively large specific surface area of the product, thereby causing relatively poor processing performance of a final product.

In some embodiments, in the mixed solution II, a molar ratio of manganese elements, iron elements, lithium elements, and phosphorus elements is (0.4-0.6):(0.4-0.6):(1.02-1.05):1. For example, the molar ratio of manganese elements, iron elements, lithium elements, and phosphorus elements can be 0.4:0.4:1.02:1; or the molar ratio of manganese elements, iron elements, lithium elements, and phosphorus elements can be 0.6:0.4:1.02:1; or the molar ratio of manganese elements, iron elements, lithium elements, and phosphorus elements can be 0.5:0.4:1.02:1; or the molar ratio of manganese elements, iron elements, lithium elements, and phosphorus elements can be 0.4:0.6:1.02:1; or the molar ratio of manganese elements, iron elements, lithium elements, and phosphorus elements can be 0.4:0.5:1.02:1; or the molar ratio of manganese elements, iron elements, lithium elements, and phosphorus elements can be 0.4:0.4:1.05:1; or the molar ratio of manganese elements, iron elements, lithium elements, and phosphorus elements can be 0.4:0.4:1.03:1; or the molar ratio of manganese elements, iron elements, lithium elements, and phosphorus elements can be 0.4:0.4:1.04:1; or the molar ratio of manganese elements, iron elements, lithium elements, and phosphorus elements can be 0.6:0.4:1.05:1; or the molar ratio of manganese elements, iron elements, lithium elements, and phosphorus elements can be 0.5:0.4:1.04:1; or the molar ratio of manganese elements, iron elements, lithium elements, and phosphorus elements can be 0.5:0.6:1.05:1; or the molar ratio of manganese elements, iron elements, lithium elements, and phosphorus elements can be 0.5:0.5:1.04:1.

In some embodiments, in the mixed solution II, a molar ratio of magnesium elements, aluminum elements, and manganese elements is (0.01-0.02):(0.005-0.01):1, optionally (0.012-0.018):(0.007-0.09):1. For example, the molar ratio of magnesium elements, aluminum elements, and manganese elements can be 0.01:0.005:1; or the molar ratio of magnesium elements, aluminum elements, and manganese elements can be 0.02:0.005:1; or the molar ratio of magnesium elements, aluminum elements, and manganese elements can be 0.015:0.005:1; or the molar ratio of magnesium elements, aluminum elements, and manganese elements can be 0.01:0.01:1; or the molar ratio of magnesium elements, aluminum elements, and manganese elements can be 0.01:0.006:1; or the molar ratio of magnesium elements, aluminum elements, and manganese elements can be 0.01:0.007:1; or the molar ratio of magnesium elements, aluminum elements, and manganese elements can be 0.01:0.008:1; or the molar ratio of magnesium elements, aluminum elements, and manganese elements can be 0.01:0.009:1; or the molar ratio of magnesium elements, aluminum elements, and manganese elements can be 0.02:0.006:1; or the molar ratio of magnesium elements, aluminum elements, and manganese elements can be 0.02:0.007:1; or the molar ratio of magnesium elements, aluminum elements, and manganese elements can be 0.02:0.008:1; or the molar ratio of magnesium elements, aluminum elements, and manganese elements can be 0.02:0.009:1; or the molar ratio of magnesium elements, aluminum elements, and manganese elements can be 0.015:0.01:1; or the molar ratio of magnesium elements, aluminum elements, and manganese elements can be 0.015:0.006:1; or the molar ratio of magnesium elements, aluminum elements, and manganese elements can be 0.015:0.007:1; or the molar ratio of magnesium elements, aluminum elements, and manganese elements can be 0.015:0.008:1; or the molar ratio of magnesium elements, aluminum elements, and manganese elements can be 0.015:0.009:1.

In the present disclosure, if the magnesium and aluminum are doped too much, the capacity of the lithium manganese iron phosphate material will be low, thereby reducing the cycling performance.

In some embodiments, a content of carbon elements in the lithium manganese iron phosphate material is ranged from 1.5 wt % to 2.5 wt %, that is, a mass fraction of the carbon elements is 1.5% to 2.5%. Typically but not restrictively, for example, the content of carbon elements in the lithium manganese iron phosphate material can be 1.5 wt %, 1.7 wt %, 1.9 wt %, 2 wt %, 2.2 wt %, 2.4 wt %, 2.5 wt %, or a range defined by any two of the values.

In some embodiments, the step 10 further includes preparing the mixed solution I by reacting a mixed material containing an iron powder, a manganese powder, and lithium carbonate with an acetic acid solution, solid-liquid separation, and then obtaining the mixed solution I.

In some embodiments, in the steps of preparing the mixed solution I, a molar ratio of the iron powder, the manganese powder, lithium carbonate, and acetic acid in the acetic acid solution is (0.4-0.6):(0.4-0.6):(0.501-0.51):(3.3-3.5). For example, the molar ratio of the iron powder, the manganese powder, lithium carbonate, and acetic acid in the acetic acid solution is 0.4:0.4:0.501:3.3; or the molar ratio of the iron powder, the manganese powder, lithium carbonate, and acetic acid in the acetic acid solution is 0.4:0.6:0.501:3.3; or the molar ratio of the iron powder, the manganese powder, lithium carbonate, and acetic acid in the acetic acid solution is 0.4:0.5:0.51:3.3; or the molar ratio of the iron powder, the manganese powder, lithium carbonate, and acetic acid in the acetic acid solution is 0.4:0.5:0.505:3.5; or the molar ratio of the iron powder, the manganese powder, lithium carbonate, and acetic acid in the acetic acid solution is 0.4:0.6:0.51:3.4.

In some embodiments, in the steps of preparing the mixed solution I, a concentration of the acetic acid solution is 3 mol/L to 5 mol/L. For example, the concentration of the acetic acid solution can be 3 mol/L, 4 mol/L, or 5 mol/L.

In some embodiments, in the steps of preparing the mixed solution I, reacting the mixed material with the acetic acid solution is conducted at a temperature ranged from 30° C. to 50° C. For example, the mixed material and the acetic acid solution can be reacted at a temperature selected from 30° C., 32° C., 35° C., 37° C., 38° C., 40° C., 41° C., 43° C., 44° C., 46° C., 48° C., 49° C., or 50° C.

In some embodiments, in the steps of preparing the mixed solution I, the mixed material further includes a magnesium powder and an aluminum powder. Optionally, a molar ratio of the magnesium powder, the aluminum powder, and the manganese powder is (0.01-0.02):(0.005-0.01):1, further optionally (0.012-0.018):(0.007-0.09):1. For example, the molar ratio of the magnesium powder, the aluminum powder and the manganese powder can be 0.01:0.005:1; or the molar ratio of the magnesium powder, the aluminum powder and the manganese powder can be 0.01:0.01:1; or the molar ratio of the magnesium powder, the aluminum powder and the manganese powder can be 0.02:0.005:1; or the molar ratio of the magnesium powder, the aluminum powder and the manganese powder can be 0.02:0.01:1; or the molar ratio of the magnesium powder, the aluminum powder and the manganese powder can be 0.01:0.008:1; or the molar ratio of the magnesium powder, the aluminum powder and the manganese powder can be 0.012:0.007:1; or the molar ratio of the magnesium powder, the aluminum powder and the manganese powder can be 0.012:0.008:1; or the molar ratio of the magnesium powder, the aluminum powder and the manganese powder can be 0.015:0.005:1; or the molar ratio of the magnesium powder, the aluminum powder and the manganese powder can be 0.015:0.008:1; or the molar ratio of the magnesium powder, the aluminum powder and the manganese powder can be 0.018:0.005:1; or the molar ratio of the magnesium powder, the aluminum powder and the manganese powder can be 0.018:0.007:1; or the molar ratio of the magnesium powder, the aluminum powder and the manganese powder can be 0.018:0.009:1.

In some embodiments, a concentration of the phosphoric acid solution is 5 mol/L to 8 mol/L. For example, the concentration of the phosphoric acid solution can be 5 mol/L, 6 mol/L, 7 mol/L, 8 mol/L, or any value ranging from 5 mol/L to 8 mol/L.

In some embodiments, the mixed solution I and the phosphoric acid solution are mixed at room temperature.

In some embodiments, a spray material is obtained after the spray drying, a particle size of the spray material is ranged from 3 μm to 8 μm, and a moisture content of the spray material is less than 0.8 wt %. For example, the particle size of the spray material is 3 μm, 4 μm, 5 μm, 6 μm, 7 μm, 8 μm, or any value ranging from 3 μm to 8 μm.

In some embodiments, the spray drying is conducted by using a pressure spray dryer. An inlet air temperature for the spray drying is ranged from 250° C. to 350° C. Typical but not restrictively, for examples, the inlet air temperature is 250° C., 270° C., 290° C., 310° C., 330° C., 350° C., or a range defined by any two of the values.

During the spray drying, due to the volatility of acetic acid, acetate ions in the mixed solution II will be preferentially volatilized together with hydrogen ions (i.e., in a form of acetic acid). In the embodiments of the present disclosure, by adjusting the temperature of spray drying, acetic acid and water are completely volatilized, without excessive vaporization of the remaining materials. The mixed solution II is introduced into the spray dryer and is spray-dried to obtain a spray material and waste gas. The spray material is separated from the waste gas by using a cyclone dust collector and a dust collecting bag. The dust collecting bag employed is a high-temperature resistant 800-1200 mesh dust collecting bag. The waste gas is cooled with a cooling coil which contains pure water therein. The heated pure water is recycled to prepare the phosphoric acid solution. The waste gas is condensed to be a diluted acetic acid solution, whose concentration is adjusted by adding glacial acetic acid, allowing for further dissolution and use.

In addition, water and acetic acid in the mixed solution II are mostly condensed and recycled to dissolve the mixed material, which forms a closed cycle and facilitates the recycling of lithium manganese iron phosphate material preparation, thereby saving costs and ensuring basically no waste generation in the preparation process.

In some embodiments, the calcination includes: heating to a temperature ranged from 650° C. to 690° C. and holding for 9 hours to 13 hours under an inert atmosphere, and then cooling. Typically but not restrictively, for example, the calcination temperature is 650° C., 660° C., 670° C., 680° C., 690° C., or a range defined by any two of the values. The holding time is 9 h, 10 h, 11 h, 12 h, 13 h, or a range defined by any two of the values. Preferably, the inert atmosphere includes nitrogen gas.

In the solid phase method in the related art, the calcination temperature for preparing lithium manganese iron phosphate material is 700° C. In contrast, in the embodiments of the present disclosure, the calcination temperature in the calcination process is lower. At a relatively low calcination temperature, the ion migration distance is shortened, and the reaction and fusion are accelerated, thereby further improving the compacted density of the lithium manganese iron phosphate material. Moreover, the calcination is not carried out at a high temperature, which avoids the formation of large particles, thereby further improving the capacity of the lithium manganese iron phosphate material.

In some embodiments, a heating rate in the process of calcination is 2° C./min to 4° C./min. For example, the heating rate in the calcination process is 2° C./min, 3° C./min, 4° C./min, or any value ranging from 2° C./min to 4° C./min.

In some embodiments, the calcinated material is cooled to a temperature less than or equal to 100° C., and then is discharged. The spray material is first loaded into a graphite sagger by a loader, and then calcinated in a roller furnace. An air inlet port is provided in the heating stage, which is connected to an induced draft fan. Besides, nitrogen gas is introduced into the roller furnace to maintain the oxygen content in a rotary kiln to below 5 ppm, and to maintain the pressure in the rotary kiln to be 30 Pa to 60 Pa higher than the ambient pressure.

In some embodiments, the pulverization includes pulverizing the obtained calcined material to a particle size (D50 particle size) ranged from 1.5 μm to 3 μm.

In some embodiments, the pulverization is conducted by using a fluidized bed jet mill. The fluidized bed jet mill uses nitrogen gas at a temperature of 110° C. to 140° C. and a pressure of 6 kg to 8 kg as an inlet gas. The inlet gas with a flow rate of 3 Mach to 5 Mach is injected into a pulverizing chamber through a Laval nozzle. The calcined material is classified by a classifying wheel, and finally is pulverized to a particle size ranged from 1.5 μm to 3 μm.

In some embodiments, after the pulverization, the method further includes sieving and iron removal. Preferably, a 100-200 mesh screen is used for sieving, and an electromagnetic iron remover is used for iron removal.

In a third aspect, a cathode plate is provided. The cathode plate includes a current collector, and a cathode material disposed on at least one side of the current collector in the thickness direction. The cathode material includes the lithium manganese iron phosphate material as described in the first aspect.

According to the embodiments of the present disclosure, the cathode plate contains the aforementioned lithium manganese iron phosphate material, and thus has the advantages of the lithium manganese iron phosphate material.

In a fourth aspect, a secondary battery is provided. The secondary battery includes: a cathode plate, a separator, and an anode plate that are stacked one on another. The cathode plate is the cathode plate as described in the third aspect.

According to the embodiments of the present disclosure, the secondary battery includes the aforementioned cathode plate, and thus has the advantages of the cathode plate.

In a fifth aspect, an electrical device is provided. The electrical device includes: a plurality of batteries connected in series and/or in parallel. At least one of the batteries is the secondary battery as described in the fourth aspect.

According to the embodiments of the present disclosure, the electric device includes the aforementioned secondary battery, and thus has the advantages of the secondary battery.

The technical solutions of the present disclosure will be described in detail below in combination with examples and comparative examples, but those skilled in the art will understand that the following examples are only used to illustrate the present disclosure and should not be constructed as limiting the scope of the present disclosure. Embodiments with specific conditions not indicated are carried out under conventional conditions or conditions recommended by the manufacturer. The reagents or instruments used without the indication of manufacturer are all conventional products that are commercially available.

### Example 1

A lithium manganese iron phosphate material in this example was prepared according to a method including the following steps.

S1: An iron powder, a manganese powder, and lithium carbonate were uniformly mixed to obtain a mixed material, and then 4.2 mol/L of an acetic acid solution was added. The mixed material and the acetic acid solution were reacted at 40° C. until the manganese powder, iron powder, and lithium carbonate were completely dissolved, and then filtered to obtain a mixed solution I. A molar ratio of the iron powder, the manganese powder, lithium carbonate, and acetic acid in the acetic acid solution was 0.5:0.5:0.5035:3.4.

S2: 7 mol/L of a phosphoric acid solution and a soluble organic carbon source were added to the mixed solution I, stirred and mixed uniformly to obtain a mixed solution II. A molar ratio of the phosphoric acid in the phosphoric acid solution to the manganese powder was 1:0.5. The soluble organic carbon source was added to achieve 1.97 wt % of the carbon element content in the prepared lithium manganese iron phosphate material. The soluble organic carbon source includes sucrose and glucose in a mass ratio of 8:92.

S3: The mixed solution II was introduced into a pressure spray dryer for spray drying, to obtain a spray material with an average particle size (D50) of 4.8 μm and a moisture content of less than 0.8 wt % and waste gas. During the spray drying, the temperature of the inlet air was maintained at a range from 290° C. to 310° C. The spray material and the waste gas were separated by a cyclone dust collector and a high-temperature resistant 1000-mesh dust collecting bag. After that, the waste gas was cooled with a cooling coil which contained pure water therein. The heated pure water was recycled to prepare the phosphoric acid solution. The waste gas was condensed to be dilute acetic acid, whose concentration was adjusted by adding glacial acetic acid, and then returned to step S1 to react with the mixed material. The recovery rate of acetic acid in the waste gas was 88%. The recovery rate of water was 75%. The temperature of the pure water was elevated from room temperature to above 75° C.

S4: The spray material was loaded into a graphite sagger through a loader, and then calcinated in a roller furnace to obtain a calcined material. Nitrogen gas was introduced in the process of calcination. The calcination temperature was elevated to 680° C. at a rate of 3° C./min and held for 12 hours, and then was dropped to below 100° C. for material discharge. An air inlet port was provided in the heating stage, which was connected to an induced draft fan. Nitrogen gas was introduced into the roller furnace to maintain the oxygen content in a rotary kiln to below 5 ppm, and to maintain the pressure in the rotary kiln to be 50+2 Pa higher than the ambient pressure.

S5: The calcined material was pulverized by using a fluidized bed jet mill. Nitrogen gas at a temperature of 130±2° C. and a pressure of 7.2 kg was used as an inlet gas. The inlet gas with a flow rate of 4.2 Mach was injected into a pulverizing chamber through a Laval nozzle. The calcined material was classified by a classifying wheel, and finally was pulverized to an average particle size (D50) of 1.9 μm. The pulverized calcined material was then sieved with a 120-mesh screen, and an electromagnetic iron remover was used to remove iron, thereby obtaining the lithium manganese iron phosphate material.

The properties of the lithium manganese iron phosphate product prepared in this example are shown in Table 1.

TABLE 1

| Li content | Mn content | Fe content | P content |
|---|---|---|---|
| (wt %) | (wt %) | (wt %) | (wt %) |
| 4.38 | 17.13 | 17.41 | 19.31 |

| C content | Free lithium | Magnetic substance | Moisture |
|---|---|---|---|
| (wt %) | content (ppm) | content (ppm) | content (ppm) |
| 1.97 | 328 | 0.2 | 438 |

| Ca content | Na content | K content | Ni content |
|---|---|---|---|
| (ppm) | (ppm) | (ppm) | (ppm) |
| 21.7 | 24.8 | 30.7 | 3.8 |

| pH | Mg content (ppm) | Al content (ppm) |
|---|---|---|
| 9.87 | 4.8 | 9.7 |

### Example 2

A lithium manganese iron phosphate material in this example was prepared according to the method in Example 1, except that in step S1, an iron powder, a manganese powder, lithium carbonate were mixed to obtain a mixed material, and a molar ratio of the iron powder, the manganese powder, lithium carbonate, and acetic acid in the acetic acid solution was 0.4:0.6:0.501:3.3.

The properties of the lithium manganese iron phosphate product prepared in this example are shown in Table 2.

TABLE 2

| Li content | Mn content | Fe content | P content |
|---|---|---|---|
| (wt %) | (wt %) | (wt %) | (wt %) |
| 4.26 | 20.56 | 13.91 | 19.39 |

| C content | Free lithium | Magnetic substance | Moisture |
|---|---|---|---|
| (wt %) | content (ppm) | content (ppm) | content (ppm) |
| 1.96 | 197 | 0.2 | 411 |

| Ca content | Na content | K content | Ni content |
|---|---|---|---|
| (ppm) | (ppm) | (ppm) | (ppm) |
| 20.6 | 22.9 | 27.5 | 2.1 |

| pH | Mg content (ppm) | Al content (ppm) |
|---|---|---|
| 9.74 | 4.2 | 9.2 |

### Example 3 n

A lithium manganese iron phosphate material in this example was prepared according to the method in Example 1, except that in step S1, an iron powder, a manganese powder, lithium carbonate were mixed to obtain a mixed material, and a molar ratio of the iron powder, the manganese powder, lithium carbonate, and acetic acid in the acetic acid solution was 0.6:0.4:0.51:3.5.

The properties of the lithium manganese iron phosphate product prepared in this example are shown in Table 3.

TABLE 3

| Li content | Mn content | Fe content | P content |
|---|---|---|---|
| (wt %) | (wt %) | (wt %) | (wt %) |
| 4.43 | 13.45 | 21.27 | 19.27 |

| C content | Free lithium | Magnetic substance | Moisture |
|---|---|---|---|
| (wt %) | content (ppm) | content (ppm) | content (ppm) |
| 1.99 | 489 | 0.3 | 538 |

| Ca content | Na content | K content | Ni content |
|---|---|---|---|
| (ppm) | (ppm) | (ppm) | (ppm) |
| 19.5 | 22.1 | 26.7 | 1.7 |

| pH | Mg content (ppm) | Al content (ppm) |
|---|---|---|
| 10.45 | 4.4 | 9.2 |

### Example 4

A lithium manganese iron phosphate material in this example was prepared according to the method in Example 1, except that in step S1, an iron powder, a manganese powder, lithium carbonate, a magnesium powder, and an aluminum powder were mixed to obtain a mixed material, and a molar ratio of the iron powder, the manganese powder, lithium carbonate, and acetic acid in the acetic acid solution was 0.5:0.5:0.5035:3.4, and a molar ratio of the magnesium powder, the aluminum powder, and the manganese powder was 0.015:0.008:1.

The properties of the lithium manganese iron phosphate product prepared in this example are shown in Table 4.

TABLE 4

| Li content | Mn content | Fe content | P content |
|---|---|---|---|
| (wt %) | (wt %) | (wt %) | (wt %) |
| 4.32 | 17.05 | 17.27 | 19.17 |

| C content | Free lithium | Magnetic substance | Mg content |
|---|---|---|---|
| (wt %) | content (ppm) | content (ppm) | (wt %) |
| 1.94 | 317 | 0.1 | 0.44 |

| Al content | Moisture content | Ca content | Na content |
|---|---|---|---|
| (wt %) | (ppm) | (ppm) | (ppm) |
| 0.28 | 424 | 21.6 | 25.7 |

| K content (ppm) | Ni content (ppm) | pH |
|---|---|---|
| 30.1 | 2.7 | 9.47 |

### Example 5

A lithium manganese iron phosphate material in this example was prepared according to the method in Example 4, except that a molar ratio of the magnesium powder, the aluminum powder, and the manganese powder was 0.012:0.009:1.

The properties of the lithium manganese iron phosphate product prepared in this example are shown in Table 5.

TABLE 5

| Li content | Mn content | Fe content | P content |
|---|---|---|---|
| (wt %) | (wt %) | (wt %) | (wt %) |
| 4.35 | 17.08 | 17.31 | 19.20 |

| C content | Free lithium | Magnetic substance | Mg content |
|---|---|---|---|
| (wt %) | content (ppm) | content (ppm) | (wt %) |
| 1.95 | 337 | 0.1 | 0.36 |

| Al content | Moisture content | Ca content | Na content |
|---|---|---|---|
| (wt %) | (ppm) | (ppm) | (ppm) |
| 0.32 | 412 | 24.8 | 26.8 |

| K content (ppm) | Ni content (ppm) | pH |
|---|---|---|
| 27.5 | 2.6 | 9.42 |

### Example 6

A lithium manganese iron phosphate material in this example was prepared according to the method in Example 4, except that a molar ratio of the magnesium powder, the aluminum powder, and the manganese powder was 0.018:0.007:1.

The properties of the lithium manganese iron phosphate product prepared in this example are shown in Table 6.

TABLE 6

| Li content | Mn content | Fe content | P content |
|---|---|---|---|
| (wt %) | (wt %) | (wt %) | (wt %) |
| 4.31 | 17.01 | 17.24 | 19.15 |

| C content | Free lithium | Magnetic substance | Mg content |
|---|---|---|---|
| (wt %) | content (ppm) | content (ppm) | (wt %) |
| 1.93 | 333 | 0.1 | 0.51 |

| Al content | Moisture content | Ca content | Na content |
|---|---|---|---|
| (wt %) | (ppm) | (ppm) | (ppm) |
| 0.24 | 467 | 24.7 | 21.6 |

| K content (ppm) | Ni content (ppm) | pH |
|---|---|---|
| 28.5 | 2.2 | 9.49 |

### Example 7

A lithium manganese iron phosphate material in this example was prepared according to the method in Example 4, except that a molar ratio of the magnesium powder, the aluminum powder, and the manganese powder was 0.01:0.005:1.

The properties of the lithium manganese iron phosphate product prepared in this example are shown in Table 7.

TABLE 7

| Li content | Mn content | Fe content | P content |
|---|---|---|---|
| (wt %) | (wt %) | (wt %) | (wt %) |
| 4.36 | 17.11 | 17.34 | 19.27 |

| C content | Free lithium content | Magnetic substance | Mg content |
|---|---|---|---|
| (wt %) | (ppm) | content (ppm) | (wt %) |
| 1.93 | 337 | 0.1 | 0.31 |

| Al content | Moisture content | Ca content | Na content |
|---|---|---|---|
| (wt %) | (ppm) | (ppm) | (ppm) |
| 0.17 | 403 | 26.8 | 21.4 |

| K content (ppm) | Ni content (ppm) | pH |
|---|---|---|
| 20.5 | 2.1 | 9.43 |

### Example 8

A lithium manganese iron phosphate material in this example was prepared according to the method in Example 4, except that a molar ratio of the magnesium powder, the aluminum powder, and the manganese powder was 0.02:0.01:1.

The properties of the lithium manganese iron phosphate product prepared in this example are shown in Table 8.

TABLE 8

| Li content | Mn content | Fe content | P content |
|---|---|---|---|
| (wt %) | (wt %) | (wt %) | (wt %) |
| 4.27 | 16.89 | 17.02 | 19.06 |

| C content | Free lithium content | Magnetic substance | Mg content |
|---|---|---|---|
| (wt %) | (ppm) | content (ppm) | (wt %) |
| 1.95 | 357 | 0.1 | 0.58 |

| Al content | Moisture content | Ca content | Na content |
|---|---|---|---|
| (wt %) | (ppm) | (ppm) | (ppm) |
| 0.32 | 428 | 20.2 | 22.3 |

| K content (ppm) | Ni content (ppm) | pH |
|---|---|---|
| 23.5 | 2.1 | 9.53 |

### Example 9

A lithium manganese iron phosphate material in this example was prepared according to the method in Example 4, except that a molar ratio of the magnesium powder, the aluminum powder, and the manganese powder was 0.025:0.01:1.

The properties of the lithium manganese iron phosphate product prepared in this example are shown in Table 9.

TABLE 9

| Li content | Mn content | Fe content | P content |
|---|---|---|---|
| (wt %) | (wt %) | (wt %) | (wt %) |
| 4.25 | 16.85 | 17.00 | 19.02 |

| C content | Free lithium content | Magnetic substance | Mg content |
|---|---|---|---|
| (wt %) | (ppm) | content (ppm) | (wt %) |
| 1.95 | 325 | 0.1 | 0.71 |

| Al content | Moisture content | Ca content | Na content |
|---|---|---|---|
| (wt %) | (ppm) | (ppm) | (ppm) |
| 0.32 | 447 | 20.1 | 21.7 |

| K content (ppm) | Ni content (ppm) | pH |
|---|---|---|
| 20.7 | 2.6 | 9.52 |

### Example 10

A lithium manganese iron phosphate material in this example was prepared according to the method in Example 4, except that a molar ratio of the magnesium powder, the aluminum powder, and the manganese powder was 0.02:0.012:1.

### Example 11

A lithium manganese iron phosphate material in this example was prepared according to the method in Example 4, except that a molar ratio of the magnesium powder, the aluminum powder, and the manganese powder was 0.05:0.015:1.

### Example 12

A lithium manganese iron phosphate material in this example was prepared according to the method in Example 4, except that in step S2, sucrose was replaced with m-phenylenediamine.

The properties of the lithium manganese iron phosphate product prepared in this example are shown in Table 10.

TABLE 10

| Li content | Mn content | Fe content | P content |
|---|---|---|---|
| (wt %) | (wt %) | (wt %) | (wt %) |
| 4.33 | 17.06 | 17.23 | 19.15 |

| C content | Free lithium content | Magnetic substance | Mg content |
|---|---|---|---|
| (wt %) | (ppm) | content (ppm) | (wt %) |
| 1.96 | 310 | 0.1 | 0.43 |

| Al content | Moisture content | Ca content | Na content |
|---|---|---|---|
| (wt %) | (ppm) | (ppm) | (ppm) |
| 0.27 | 411 | 21.1 | 25.1 |

| K content (ppm) | Ni content (ppm) | pH | N content (wt %) |
|---|---|---|---|
| 31.4 | 2.3 | 9.45 | 0.07 |

### Example 13

A lithium manganese iron phosphate material in this example was prepared according to the method in Example 12, except that in step S1, a molar ratio of the magnesium powder, the aluminum powder, and the manganese powder was 0.03:0.008:1.

### Example 14

A lithium manganese iron phosphate material in this example was prepared according to the method in Example 12, except that in step S2, a mass ratio of m-phenylenediamine to glucose was 15:85.

### Example 15

A lithium manganese iron phosphate material in this example was prepared according to the method in Example 12, except that in step S4, the calcination temperature was elevated to 650° C. at a rate of 4° C./min and held for 13 hours.

### Example 16

A lithium manganese iron phosphate material in this example was prepared according to the method in Example 12, except that in step S4, the calcination temperature was elevated to 690° C. at a rate of 2° C./min and held for 9 hours.

### Example 17

A lithium manganese iron phosphate material in this example was prepared according to the method in Example 12, except that in step S4, the calcination temperature was elevated to 700° C. at a rate of 3° C./min and held for 13 hours.

### Comparative Example 1

A lithium manganese iron phosphate material in this comparative example was prepared according to a method including the following steps.

Iron oxide red, trimanganese tetroxide, lithium dihydrogen phosphate, and glucose in a molar ratio of 1:0.667:4.06:0.07 were added to pure water and slurried, to obtain a solid content of 32 wt %. The resulting mixture was ground with a sand mill to a particle size of 335 nm, and then spray-dried, calcined, pulverized, sieved, and iron-removed successively to obtain the lithium manganese iron phosphate material. The processes of spray drying, calcination, pulverization, sieving, and iron-removal were conducted according to Example 12.

The properties of the lithium manganese iron phosphate product prepared in the comparative example are shown in Table 11.

TABLE 11

| Li content | Mn content | Fe content | P content |
|---|---|---|---|
| (wt %) | (wt %) | (wt %) | (wt %) |
| 4.50 | 17.78 | 18.11 | 19.21 |

| C content | Free lithium content | Magnetic substance | Mg content |
|---|---|---|---|
| (wt %) | (ppm) | content (ppm) | (wt %) |
| 1.89 | 198 | 0.18 | 0.005 |

| Al content | Moisture content | Ca content | Na content |
|---|---|---|---|
| (wt %) | (ppm) | (ppm) | (ppm) |
| 0.002 | 612 | 36.8 | 76.3 |

| K content (ppm) | Ni content (ppm) | pH |
|---|---|---|
| 14.8 | 1.2 | 9.03 |

### Comparative Example 2

A lithium manganese iron phosphate material in this comparative example was prepared according to a method including the following steps.

Ferrous sulfate, manganese sulfate, lithium hydroxide, and monoammonium phosphate were added to pure water, then loaded into a hydrothermal reactor, stirred and dispersed, to obtain a solid content of 25 wt %. The raw materials were heated to a temperature of 190° C. under stirring, and then reacted for 16 h at a pressure of 11.5 MPa. After that, the obtained material was discharged, filtered and washed, and then slurried with water, and glucose was added. The resulting mixture was ground with a sand mill to a particle size of 330 nm, and then spray-dried, calcined, pulverized, sieved, and iron-removed successively to obtain the lithium manganese iron phosphate material.

A molar ratio of ferrous sulfate, manganese sulfate, lithium hydroxide, monoammonium phosphate, and glucose was 1:1:2.03:1.01:0.035. The processes of spray drying, calcination, pulverization, sieving, and iron-removal were conducted according to Comparative Example 1.

The properties of the lithium manganese iron phosphate product prepared in the comparative example are shown in Table 12.

TABLE 12

| Li content | Mn content | Fe content | P content |
|---|---|---|---|
| (wt %) | (wt %) | (wt %) | (wt %) |
| 4.48 | 17.61 | 17.89 | 19.53 |

| C content | Free lithium content | Magnetic substance | Mg content |
|---|---|---|---|
| (wt %) | (ppm) | content (ppm) | (wt %) |
| 1.99 | 209 | 0.11 | 0.0035 |

| Al content | Moisture content | Ca content | Na content |
|---|---|---|---|
| (wt %) | (ppm) | (ppm) | (ppm) |
| 0.0012 | 789 | 27.5 | 36.3 |

| K content (ppm) | Ni content (ppm) | pH |
|---|---|---|
| 11.9 | 1.1 | 9.04 |

### Test Example 1

1. Performances of the lithium manganese iron phosphate products prepared in Examples 1-12 and Comparative Examples 1-2 were tested according to the following methods. The Fe content was determined by potentiometric titration. The phosphorus content was determined by quinoline phosphomolybdate weighing method. Contents of lithium, sodium, potassium, calcium, magnesium, nickel, and aluminum were determined by inductively coupled plasma atomic emission spectrometry. The free lithium content was determined by automatic potentiometric titration. The moisture content in the lithium manganese iron phosphate material was tested by KF method. The magnetic substances in the lithium manganese iron phosphate material were collected with a magnet, then dissolved with aqua regia, and tested by using an atomic absorption spectrometer. The pH value of the lithium manganese iron phosphate material was tested with a pH meter through acid-base potentiometric titration. The specific test results are shown in Tables 1-12. In Examples 1-3, magnesium and aluminum were not added, so that the test showed trace amounts of magnesium and aluminum, i.e., at a ppm level.

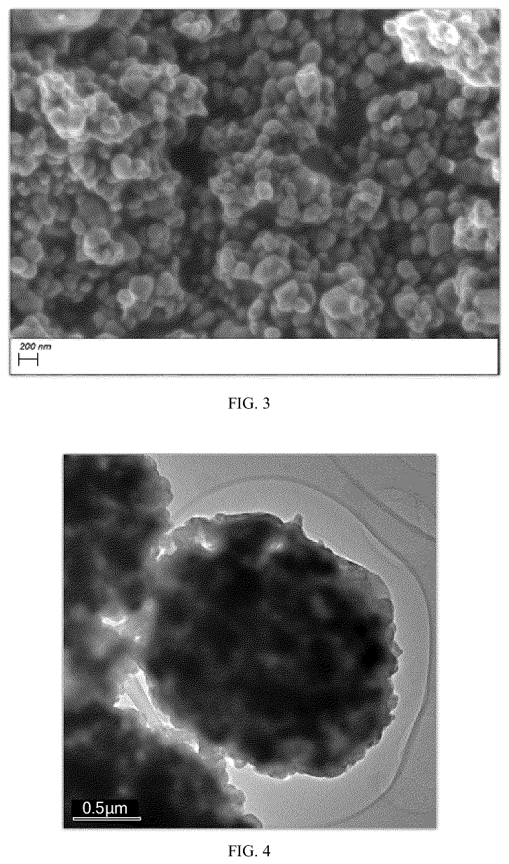

2. Fluidity and stacking property of the lithium manganese iron phosphate material are directly affected by its sphericity. The lithium manganese iron phosphate product prepared in Example 12 was tested by scanning electron microscopy, and the result is shown in FIG. 3. As can be seen from FIG. 3, the particles of the present lithium manganese iron phosphate material had high sphericity, with an average primary particle size of 186 nm.

In addition, the sphericity of the lithium manganese iron phosphate material can be measured by combining microscopic measurement and image processing technology. The images of particles were processed and analyzed with image analysis software, to obtain the particle size and particle shape of each of the particles, which were then statistically analyzed to obtain particle size (D50) and particle size distribution, average major diameter and aspect ratio distribution, average circularity and circularity distribution, and other results. Here, the sphericity of the lithium manganese iron phosphate material is represented by the average circularity. The results showed that the sphericity of the lithium manganese iron phosphate material in the Examples was above 86%, and the average primary particle size was ranged from 170 nm to 220 nm. The specific test results are shown in Table 13 below.

TABLE 13

| | Sphericity of lithium | |
|---|---|---|
| | manganese iron phosphate | Average primary |
| Group | material (%) | particle size (nm) |
| Example 1 | 89 | 210 |
| Example 2 | 86 | 213 |
| Example 3 | 90 | 201 |
| Example 4 | 91 | 193 |
| Example 5 | 93 | 187 |
| Example 6 | 94 | 183 |
| Example 7 | 90 | 199 |
| Example 8 | 89 | 188 |
| Example 9 | 91 | 180 |
| Example 10 | 94 | 178 |
| Example 11 | 95 | 172 |
| Example 12 | 97 | 186 |
| Example 13 | 96 | 179 |
| Example 14 | 92 | 191 |
| Example 15 | 78 | 173 |
| Example 16 | 85 | 185 |
| Example 17 | 91 | 218 |
| Comparative Example 1 | 68 | 243 |
| Comparative Example 2 | 76 | 154 |

3. The lithium manganese iron phosphate product prepared in Example 12 was tested by transmission electron microscopy, and the result was shown in FIG. 4. It can be seen from FIG. 4 that the surface of the lithium manganese iron phosphate was coated with a carbon layer, with very complete and uniform coating effect.

The thickness of the coating layer was measured by transmission electron microscopy. The coating rate of the coating layer was defined as the percentage of the coverage area of the coating layer on the surface of the particle (i.e., the lithium manganese iron phosphate in Examples 1-17) to the total surface area of the particle. The coating amount of the coating layer was determined by diffuse reflectance infrared Fourier transform spectroscopy. The coating rate can be calculated based on the coating amount and a sectional area (i.e., a cross-sectional area) of the coating layer according to a calculation formula:

$$n = \frac{M}{q} {N}_{A} {a}_{0} / {S}_{w} ,$$

where n indicates the coating rate, M indicates the coating amount, q indicates a molecular weight of the coating layer, N_{A} is a constant (6.023×10²³), a₀ indicates the sectional area of the coating layer, and S_{w} indicates a specific surface area of particle.

According to the above measurement and calculation, the content of the carbon material on the surface of the present lithium manganese iron phosphate was 1.5 wt % to 2.5 wt %, and the coverage rate was above 98.0%. The specific test results are shown in Table 14 below.

TABLE 14

| Group | Coverage rate of carbon material (%) |
|---|---|
| Example 1 | 98.9 |
| Example 2 | 98.8 |
| Example 3 | 98.8 |
| Example 4 | 98.9 |
| Example 5 | 99.0 |
| Example 6 | 98.9 |
| Example 7 | 98.9 |
| Example 8 | 99.0 |
| Example 9 | 98.8 |
| Example 10 | 98.9 |
| Example 11 | 98.8 |
| Example 12 | 99.6 |
| Example 13 | 98.1 |
| Example 14 | 97.4 |
| Example 15 | 97.3 |
| Example 16 | 96.7 |
| Example 17 | 96.7 |
| Comparative Example 1 | 96.3 |
| Comparative Example 2 | 96.6 |

4. The particle size distribution and specific surface area of the lithium manganese iron phosphate products in Examples 1-2, Examples 4-5, Examples 12 and 17, and Comparative Examples 1-2 were tested. The results are shown in Table 15.

TABLE 15

| | Particle size distribution | | | Specific |
|---|---|---|---|---|
| | D10 particle | D50 particle | D90 particle | surface |
| Group | size (μm) | size (μm) | size (μm) | area (m²/g) |
| Example 1 | 0.39 | 1.8 | 7.4 | 14.7 |
| Example 2 | 0.36 | 1.8 | 7.6 | 14.5 |
| Example 4 | 0.34 | 1.7 | 7.5 | 14.8 |
| Example 5 | 0.35 | 1.8 | 7.8 | 14.7 |
| Example 12 | 0.41 | 1.9 | 7.5 | 14.9 |
| Example 17 | 0.48 | 1.96 | 9.49 | 10.38 |
| Comparative | 0.41 | 1.81 | 8.7 | 15.7 |
| Example 1 | | | | |
| Comparative | 0.38 | 1.56 | 10.13 | 15.8 |
| Example 2 | | | | |

The specific surface area of the lithium manganese iron phosphate material in Table 15 was determined by BET specific surface area test, such as nitrogen adsorption multi-point BET test. The D50 particle size, D90 particle size, and D10 particle size in the particle size distribution of the lithium manganese iron phosphate material was determined with a laser particle size analyzer (Mastersizer 3000 laser particle size analyzer, from Malvern Instruments Ltd., UK). The D50 particle size refers to the particle size corresponding to a cumulative volume distribution percentage of the lithium manganese iron phosphate material of 50%. D10 particle size refers to the particle size corresponding to a cumulative volume distribution percentage of the lithium manganese iron phosphate material of 10%. D90 particle size refers to the particle size corresponding to a cumulative volume distribution percentage of the lithium manganese iron phosphate material of 90%.

It can be seen from Table 15 that D90 particle sizes of Examples 1-2, Examples 4-5 and Example 12 were relatively small, the particle size distribution thereof was more concentrated and uniform, and the specific surface areas thereof were relatively large, which suggests effectively improved compacted density, thereby capable of improving the density of the cathode plate. When the spray material was calcined at 700° C., as shown in Example 17, the D90 particle size of the lithium manganese iron phosphate material was significantly increased and the specific surface area was significantly decreased, which suggests that a lower calcination temperature can facilitate to shorten ion migration distance and to accelerate the reaction and fusion, thereby avoiding the generation of large particles, and thus improving the compacted density of the lithium manganese iron phosphate material.

5. The powder resistivity, compacted density (PD), tap density (TD), and manganese dissolution rate of the lithium manganese iron phosphate products in Examples 1, 4, 12, 14-17, and Comparative Examples 1-2 were tested. The test results are shown in Table 16 below.

TABLE 16

| | | | | Percent of manganese |
|---|---|---|---|---|
| | | | | dissolution to manganese |
| | Powder | | | content in lithium |
| | resistivity | PD | TD | manganese iron phosphate |
| Group | (Ω · cm) | (g/mL) | (g/mL) | (%) |
| Example 1 | 12.5 | 2.32 | 1.1 | 0.05 |
| Example 4 | 12.3 | 2.40 | 1.2 | 0.04 |
| Example 12 | 8.7 | 2.41 | 1.2 | 0.02 |
| Example 14 | 11.2 | 2.40 | 1.1 | 0.03 |
| Example 15 | 11.8 | 2.35 | 1.1 | 0.05 |
| Example 16 | 8.2 | 2.41 | 1.2 | 0.02 |
| Example 17 | 9.1 | 2.45 | 1.2 | 0.36 |
| Comparative | 198.6 | 2.29 | 1.1 | 2.5 |
| Example 1 | | | | |
| Comparative | 126.7 | 2.32 | 1.2 | 0.8 |
| Example 2 | | | | |

The powder resistivity in Table 16 was measured by four-probe test at a test pressure of 10 MPa.

Compacted density (PD) was measured with an electronic powder compactor at a test pressure of 3T.

Tap density (TD) was measured as follows: 100.00 g of test material was taken and added into a 100 mL standard measuring cylinder, and vibrated 1000 times with an amplitude of 2 cm. A density (i.e., tap density) was obtained by dividing mass by volume.

Manganese dissolution was measured as follows: 10 g of the lithium manganese iron phosphate product was added to 90 g of 0.1 mol/L hydrochloric acid solution, stirred and mixed at 25° C. for 30 minutes, and then filtered. The manganese element in the filtrate was measured by ICP-OES to obtain the manganese dissolution.

It can be seen from FIG. 3, and Tables 13 and 16 that the particles of the present lithium manganese iron phosphate material had high sphericity, an average primary particle size of 170 nm to 220 nm, and a high degree of compactness. Although the particles were not large, the compacted density could reach more than 2.30 g/mL, which ensures compacted density and capacity while maintaining small particles.

In the present disclosure, manganese, iron, lithium, and phosphorus are mixed at ionic levels, which greatly shortens the ion diffusion distance during high-temperature calcination and avoids the segregation of manganese and iron, thereby ensuring the capacity of the product. Besides, in the present disclosure, aluminum is introduced, which improves the density of the particles to a certain extent, thereby capable of maintaining a relatively high compacted density at a relatively low calcination temperature.

In addition, the doping of magnesium and aluminum can improve the ionic conductivity. Furthermore, the doping of magnesium can significantly reduce the dissolution of manganese, thereby improving the cycling performance. The doping of aluminum can improve the compacted density and rate capability.

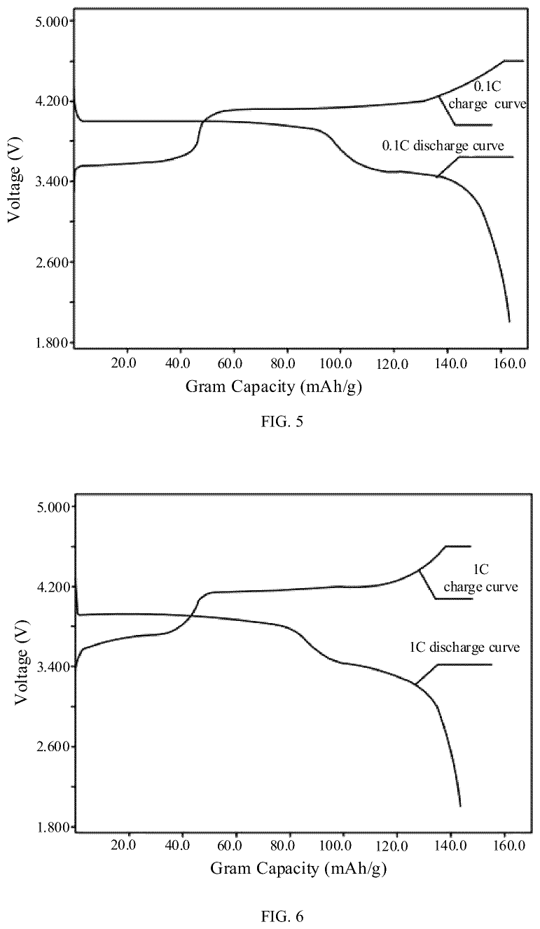

6. The cathode material was prepared with 83:8:2:7 of lithium manganese iron phosphate material: SP: CNT: PVDF. The electrochemical properties of the lithium manganese iron phosphate materials prepared in Examples 1, 4, 12-17 and Comparative Examples 1-2 were tested. The results are shown in Table 17. 0.1C charge and discharge curves and 1C charge and discharge curves of the lithium manganese iron phosphate material in Example 12 are respectively shown in FIG. 5 and FIG. 6.

0.1C charge capacity, 0.1C discharge capacity and initial discharge efficiency were measured by using a power-off test system. 1C discharge capacity, and capacity retention rate after 1000 cycles at 1C rate under ambient temperature were measured by using flexible test leads for in-line measurement. The soft pack had a capacity of 0.5 Ah.

TABLE 17

| | | | | | | Capacity |
|---|---|---|---|---|---|---|
| | | | | | | retention rate |
| | 0.1 C | 0.1 C | Initial | Constant | 1 C | after 1000 |
| | charge | discharge | discharge | voltage | discharge | cycles at 1 C rate |
| | capacity | capacity | efficiency | ratio at | capacity | under ambient |
| Group | (mAh/g) | (mAh/g) | (%) | 0.1 C (%) | (mAh/g) | temperature (%) |
| Example 1 | 160.1 | 154.2 | 96.3 | 6.4 | 132.5 | 87.5 |
| Example 4 | 161.1 | 156.9 | 97.4 | 4.9 | 139.1 | 88.5 |
| Example 12 | 168.1 | 161.9 | 96.3 | 3.6 | 145.8 | 90.4 |
| Example 13 | 166.2 | 158.9 | 95.6 | 3.9 | 144.3 | 89.1 |
| Example 14 | 165.3 | 160.2 | 96.9 | 4.0 | 143.2 | 89.0 |
| Example 15 | 168.0 | 160.3 | 95.4 | 4.2 | 144.4 | 90.1 |
| Example 16 | 162.6 | 157.2 | 96.7 | 4.1 | 136.5 | 87.9 |
| Example 17 | 157.5 | 152.4 | 96.8 | 8.3 | 131.1 | 86.7 |
| Comparative | 158.1 | 152.5 | 96.5 | 8.9 | 130.1 | 86.1 |
| Example 1 | | | | | | |
| Comparative | 158.5 | 153.3 | 96.7 | 8.5 | 130.2 | 86.4 |
| Example 2 | | | | | | |

It can be seen from FIGS. 5, 6 and Table 17 that the present lithium manganese iron phosphate material has relatively high manganese capacity in the discharge process (i.e., the capacity ranged from 3.75 V to 4.6V), and the manganese capacity is basically fully released, indicating a relatively good manganese-iron eutectic, with basically no manganese segregation phenomenon.

It can be seen from Table 17 that compared to that in Comparative Example 1 prepared by the solid phase method, the lithium manganese iron phosphate materials in Examples 1-17, which were prepared by dispersing raw materials in ionic states into the aqueous solution to render effectively improved mixing uniformity and reduced manganese segregation and manganese dissolution, exhibited significantly improved charge specific capacity, discharge specific capacity, and capacity retention rate after 1000 cycles when applied to batteries, which indicates improvements in electrochemical properties such as cycling performance and capacity performance. In addition, since the raw materials had been mixed at ionic level before spray drying, reduced calcination temperature avoids the formation of large particles, thereby obtaining the lithium manganese iron phosphate material with improved cycling performance and capacity performance.

In combination with Tables 1-17 above, compared to Comparative Example 2, the surface of the lithium manganese iron phosphate in Examples 1-17 was coated with a carbon layer.

Combining Example 1 with Examples 4-17, it can be seen that the doping of magnesium and aluminum elements in the lithium manganese iron phosphate material further improves the compacted density, cycling performance and rate capability of the lithium manganese iron phosphate material. In addition, the molar ratio of manganese, iron, lithium, and phosphorus in the raw materials of the lithium manganese iron phosphate material is controlled to be in a range of (0.4-0.6):(0.4-0.6):(1.02-1.05):1, and the molar ratio of magnesium, aluminum, and manganese is controlled to be in a range of (0.01-0.02):(0.005-0.01):1, which is beneficial to obtain a lithium manganese iron phosphate material with improved cycling performance and rate capability and relatively high capacity.

It can be seen from the results in Tables 16 and 17 of Example 12 that when m-phenylenediamine is used as the soluble organic carbon source, the structure of m-phenylenediamine contains both a benzene ring and amino group. The formed coating layer has a high degree of graphitization, which reduces the powder resistivity and improves the electrical conductivity of the lithium manganese iron phosphate material. Furthermore, nitrogen element is introduced, which further improves the electrical conductivity of the lithium manganese iron phosphate material.

Although the present disclosure has been illustrated and described with specific embodiments, it should be appreciated that the aforementioned embodiments are only used to illustrate the technical solutions of the present disclosure, but not to limit the present disclosure. A person skilled in the art should understand that modifications to technical solutions recited in the aforementioned embodiments or equivalent replacements of some or all of the technical features therein can be made without departing from the spirit and scope of the present disclosure. However, these modifications or replacements do not make the essence of the corresponding technical solutions deviate from the scope of the technical solutions of the embodiments of the present disclosure. Therefore, all such replacements and modifications falling within the scope of the present disclosure are included in the appended claims.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present disclosure.

The above-described embodiments are only several implementations of the present disclosure, and the descriptions are relatively specific and detailed, but they should not be construed as limiting the scope of the present disclosure. It should be understood by those of ordinary skill in the art that various modifications and improvements can be made without departing from the concept of the present disclosure, and all fall within the protection scope of the present disclosure. Therefore, the patent protection of the present disclosure shall be defined by the appended claims.

1. A lithium manganese iron phosphate material, comprising a core, wherein a material of the core is represented by a general formula of LiₓMg_{y}Mn_{z}FeₐAl_{b}PO₄, where x is ranged from 1.002 to 1.05, y is ranged from 0 to 0.009, z is ranged from 0.4 to 0.6, a is ranged from 0.388 to 0.6, and b is ranged from 0 to 0.012.

2. The lithium manganese iron phosphate material according to claim 1, further comprising a coating layer coated on a surface of the core, wherein a material of the coating layer comprises a carbon material;
a mass fraction of the carbon material is ranged from 1.5% to 2.5%, and/or a coverage rate of the carbon material is ranged from 98.0% to 99.9%.

3. The lithium manganese iron phosphate material according to claim 1, satisfying at least one of the following conditions:
(1) a sphericity of the lithium manganese iron phosphate material is ranged from 0.7 to 1.0;
(2) an average primary particle size of the lithium manganese iron phosphate material is ranged from 170 nm to 220 nm;
(3) a secondary particle size of the lithium manganese iron phosphate material satisfies: 0.2 μm to 0.6 μm of D10 particle size, 1.5 μm to 3 μm of D50 particle size, and 5 μm to 15 μm of D90 particle size;
(4) a compacted density of the lithium manganese iron phosphate material is ranged from 2.35 g/mL to 2.45 g/mL;
(5) a tap density of the lithium manganese iron phosphate material is ranged from 1.1 g/mL to 1.2 g/mL;
(6) a specific surface area of the lithium manganese iron phosphate material is ranged from 13.5 m²/g to 15.5 m²/g;
(7) a powder resistivity of the lithium manganese iron phosphate material is less than 15 Ω·cm;
(8) a manganese dissolution rate of the lithium manganese iron phosphate material is less than or equal to 0.05% of a manganese content in the lithium manganese iron phosphate material; and
(9) a specific capacity of the lithium manganese iron phosphate material is ranged from 160 mAh/g to 169 mAh/g.

4. A method for preparing the lithium manganese iron phosphate material according to claim 1, comprising the following steps:
mixing a mixed solution I with a phosphoric acid solution to obtain a mixed solution II, wherein the mixed solution I comprises a first manganese salt, a first iron salt, and a first lithium salt which are all soluble salts; and
subjecting the mixed solution II to spray drying, calcination and pulverization in sequence to obtain the lithium manganese iron phosphate material.

5. The method according to claim 4, wherein the mixed solution I further comprises a first magnesium salt and a first aluminum salt which are both soluble salts.

6. The method according to claim 4, wherein in the mixed solution II, a molar ratio of manganese elements, iron elements, lithium elements, and phosphorus elements is (0.4-0.6):(0.4-0.6):(1.02-1.05):1.

7. The method according to claim 6, wherein in the mixed solution II, a molar ratio of magnesium elements, aluminum elements, and manganese elements is (0.01-0.02):(0.005-0.01):1.

8. The method according to claim 4, wherein the lithium manganese iron phosphate material further comprises a coating layer coated on a surface of the core, and a material of the coating layer comprises a carbon material; in the step of mixing the mixed solution I with the phosphoric acid solution to obtain the mixed solution II, the method further comprises:
mixing a soluble organic carbon source with the mixed solution I and the phosphoric acid solution.

9. The method according to claim 8, wherein the soluble organic carbon source comprises a first carbon source and a second carbon source;
and/or, the first carbon source comprises m-phenylenediamine and/or p-hydroxyaniline;
and/or, the second carbon source comprises at least one of glucose, sucrose, polyethylene glycol, and starch;
and/or, a mass ratio of the first carbon source to the second carbon source is (5-10):(90-95).

10. The method according to claim 8, wherein a content of carbon elements in the lithium manganese iron phosphate material is ranged from 1.5 wt % to 2.5 wt %.

11. The method according to claim 4, wherein the mixed solution I is prepared by reacting a mixed material containing an iron powder, a manganese powder and lithium carbonate with an acetic acid solution, solid-liquid separation, and then obtaining the mixed solution I;
and/or, the mixed material further comprises a magnesium powder and an aluminum powder.

12. The method according to claim 4, wherein an inlet air temperature for the spray drying is ranged from 250° C. to 350° C.;
and/or, a spray material is obtained after the spray drying, a particle size of the spray material is ranged from 3 μm to 8 μm, and a moisture content of the spray material is less than 0.8 wt %.

13. The method according to claim 4, wherein the calcination comprises: heating to a temperature ranged from 650° C. to 690° C. and holding for 9 hours to 13 hours under an inert atmosphere, and then cooling.

14. The method according to claim 4, wherein the pulverization comprises:
pulverizing a calcined material obtained after calcination to a particle size of 1.5 μm to 3 μm.

15. A cathode plate, comprising: a current collector, and a cathode material disposed on at least one side of the current collector in a thickness direction; wherein the cathode material comprises the lithium manganese iron phosphate material according to claim 1.

16. A secondary battery, comprising: a cathode plate, a separator, and an anode plate that are stacked one on another; wherein the cathode plate is the cathode plate according to claim 15.

17. The lithium manganese iron phosphate material according to claim 1, wherein a material of the core is represented by a general formula of LiₓMn_{z}FeₐPO₄, where x is ranged from 1.02 to 1.05, z is ranged from 0.4 to 0.6, and a is ranged from 0.4 to 0.6.

18. The lithium manganese iron phosphate material according to claim 1, wherein a ratio of y:b:z is (0.01-0.02):(0.005-0.01):1.

19. The method according to claim 4, wherein the first manganese salt comprises at least one of manganese acetate, manganese chloride, and manganese nitrate; and/or the first iron salt comprises at least one of ferrous acetate and ferrous chloride; and/or the first lithium salt comprises at least one of lithium acetate and lithium carbonate.

20. The method according to claim 5, wherein the first magnesium salt comprises at least one of magnesium acetate, magnesium chloride, and magnesium nitrate; and/or the first aluminum salt comprises at least one of aluminum acetate, aluminum chloride, and aluminum nitrate.
